(19) United States
(12) Patent Application Publication
(10) Pub. No.: US 2023/0162446 A1
(43) Pub. Date: May 25, 2023

(54) DATA PROCESSING METHOD, DATA PROCESSING DEVICE AND STORAGE MEDIUM

(71) Applicant: Beijing Tusen Zhitu Technology Co., Ltd., Beijing (CN)

(72) Inventors: Lihu Chen, Beijing (CN); He Zheng, Beijing (CN)

(21) Appl. No.: 17/986,706

(22) Filed: Nov. 14, 2022

Related U.S. Application Data
(60) Provisional application No. 63/264,403, filed on Nov. 22, 2021.

(51) Int. Cl. G06T 17/20; G06V 20/70

(52) U.S. Cl. CPC G06T 17/205; G06V 20/70; G06T 2219/004

(57) ABSTRACT

The present application provides a data processing method, a data processing device and a storage medium, wherein the method comprises: obtaining a point cloud frame; determining point cloud corresponding to the target entity in the point cloud frame as a first point cloud; adjusting coordinate of each point in the first point cloud according to a first speed to obtain a second point cloud, wherein the first speed represents the speed of the target entity; and taking the first speed as an annotation speed in response to the second point cloud meeting a preset condition. In the data processing scheme provided herein, by speed annotation of the target entity using a relation between the target entity and its corresponding point cloud, a point cloud data annotation set comprising more annotation parameters can be simply and efficiently generated for use in subsequent algorithm training.

### CROSS-REFERENCE TO RELATED APPLICATIONS

This patent document claims the benefit of priority of U.S. Provisional Application No. 63/264,403 filed on Nov. 22, 2021, entitled, “DATA PROCESSING METHOD, DATA PROCESSING DEVICE AND STORAGE MEDIUM”. The entire content of the provisional patent application is incorporated by reference herein.

### TECHNICAL FIELD

The present application relates to the field of computer technologies, and in particular to a data processing method, a data processing device and a storage medium.

### BACKGROUND

In the related art, in order to realize safer autonomous driving, it is needed to sense the surrounding environment and other moving objects (vehicles, pedestrians, etc.), and to predict the behavior and intention of the moving objects in a future period of time using the sensed data. The speed prediction of other moving objects is of great significance for the realization of the behavior and intention prediction of other moving objects. However, an algorithm model usually requires original data for training so as to achieve model optimization and obtain better prediction results.

### SUMMARY

Various described embodiments may implement a data processing scheme that can generate a data annotation set comprising the speed of a target object.

According to one aspect, a data processing method is provided to comprise: obtaining a point cloud frame, wherein the point cloud frame comprises point cloud from at least two acquisition periods, with point cloud corresponding to a target entity comprised in the point cloud from each acquisition period; determining point cloud corresponding to the target entity in the point cloud frame as a first point cloud;

adjusting coordinate of each point in the first point cloud according to a first speed to obtain a second point cloud, wherein the first speed represents the moving speed of the target entity; and taking the first speed as an annotation speed in response to the second point cloud meeting a preset condition.

According to another aspect, a data processing device comprises a processor and at least one memory, wherein the at least one memory stores at least one machine-executable instruction, and the processor executes the at least one machine-executable instruction to implement the method as described above.

According to yet another aspect, a computer-readable storage medium has a computer program stored thereon, wherein the program is executed by a processor to implement the method as described above.

In the data processing scheme provided in the embodiments, the coordinate of each point in the point cloud of the target entity from a plurality of acquisition periods are adjusted according to the assumed speed of the target entity; by speed annotation of the target entity using a relation between the target entity and its corresponding point cloud, a point cloud data annotation set comprising more annotation parameters can be simply and efficiently generated for use in subsequent algorithm training.

### BRIEF DESCRIPTION OF THE DRAWINGS

The accompanying drawings illustrate the exemplary embodiments and constitute a part of the specification, and, together with the text description of the specification, are provided to illustrate the exemplary implementations of the embodiments. It is obvious that the accompanying drawings described below are only some embodiments of the present application. For one of ordinary skilled in the art, other drawings can be derived from the accompanying drawings without creative effort. Throughout the accompanying drawings, identical reference numerals designate similar, but not necessarily identical, elements.

FIG. 1 is a block diagram illustrating the structure of a data processing device according to an exemplary embodiment;

FIG. 2 is a schematic diagram illustrating the architecture of a data processing device according to an exemplary embodiment;

FIG. 3 is one flowchart illustrating a data processing method according to an exemplary embodiment;

FIG. 4 is another flowchart illustrating a data processing method according to an exemplary embodiment;

FIGS. 5a-5c are one schematic diagram illustrating a practical application scenario according to an exemplary embodiment, wherein three instances of speed determination are shown, respectively;

FIG. 6 is another schematic diagram illustrating a practical application scenario according to an exemplary embodiment;

FIG. 7 is yet another schematic diagram illustrating a practical application scenario according to an exemplary embodiment.

### DETAILED DESCRIPTION

The technical schemes in the embodiments of the present application will be clearly and completely described below with reference to the accompanying drawings in the embodiments of the present application. It is obvious that the described embodiments are only part of the embodiments of the present application rather than all of the embodiments. All other embodiments obtained by one of ordinary skilled in the art without making any creative effort based on the embodiments of the present application shall fall within the protection scope of the present application.

In the present disclosure, unless otherwise specified, the term “plurality” means two or more. In the present disclosure, the term “and/or” describes an associative relationship between associated objects, and encompasses any of and all possible combinations of the listed objects. The character “/” generally indicates an “or” relationship between the associated objects.

In the present disclosure, unless otherwise specified, the terms “first”, “second”, and the like are used for distinguishing between similar objects, and are not intended to limit position relationships, timing relationships, or importance relationships thereof. It is to be understood that the terms used in this manner are interchangeable under appropriate circumstances so that the embodiments of the present application described herein can be implemented in other manners in addition to those illustrated or described herein.

Moreover, the terms “comprise” and “have” and any variations thereof are intended to cover non-exclusive inclusion. For example, a process, method, system, product or device comprising a series of steps or units is not necessarily limited to the explicitly listed steps or units, but may comprise other steps or units that are not explicitly listed or are inherent in the process, method, system, product or device.

The term “target entity” in the present application may include other vehicles or moving objects traveling on a road, which are not limited herein.

In the prior art, point cloud annotation is usually performed to annotate the position of environment or the other moving objects. There have been efforts regarding how to generate a richer annotation data set comprising the speed of moving objects for use in algorithm training.

A point cloud is a set of sampling points on the surfaces of an object obtained by a measuring instrument. Specifically, point cloud obtained according to the laser measurement principle comprise three-dimensional coordinates (XYZ) and laser reflection intensity; point cloud obtained according to the photographic surveying principle comprise three-dimensional coordinates (XYZ) and color information (RGB); point cloud obtained according to the combination of the laser measurement principle and the photographic surveying principle comprise three-dimensional coordinates (XYZ), laser reflection intensity and color information (RGB).

In the related art, an autonomous vehicle will inevitably undergo various environments in the actual traveling process, thus sensing or behavior prediction of other moving vehicles in the traveling process are crucial to the safe traveling of the autonomous vehicle. However, according to the present development of autonomous driving systems, the prediction algorithm training requires a large amount of data sets.

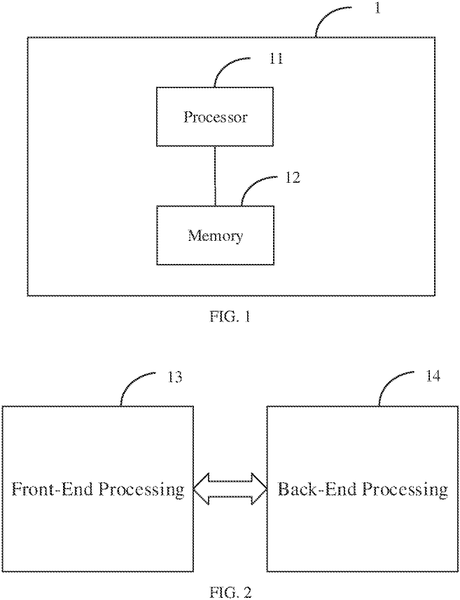

Some embodiments of the present application provide a data processing scheme. FIG. 1 shows a structure of a data processing device provided in an embodiment of the present application, wherein the device 1 comprises a processor 11 and a memory 12.

In some embodiments, the memory 12 may be a storage device in various modalities, such as a transitory or non-transitory storage medium. At least one machine-executable instruction may be stored in the memory 12, and the at least one machine-executable instruction is executed by the processor 11 to implement the data processing method provided in an embodiment of the present application. In some embodiments, the data processing device 1 may be located in a server. In some other embodiments, the data processing device 1 may also be located in a cloud server. In some other embodiments, the data processing device 1 may also be located in a client.

As shown in FIG. 2, the data processing provided in an embodiment of the present application may comprise a front-end processing 13 and a back-end processing 14. Relevant three-dimensional point cloud frames and/or images are displayed and relevant data or information input by an annotator is received through the front-end processing 13. For example, the front-end processing 13 may be achieved through a web page or an individual application interface. The back-end processing 14 performs corresponding data processing according to the relevant data and information received by the front-end processing 13. After the data processing is completed, the data processing device 1 can further provide annotation results to other processing or applications on the client, the server, and the cloud server.

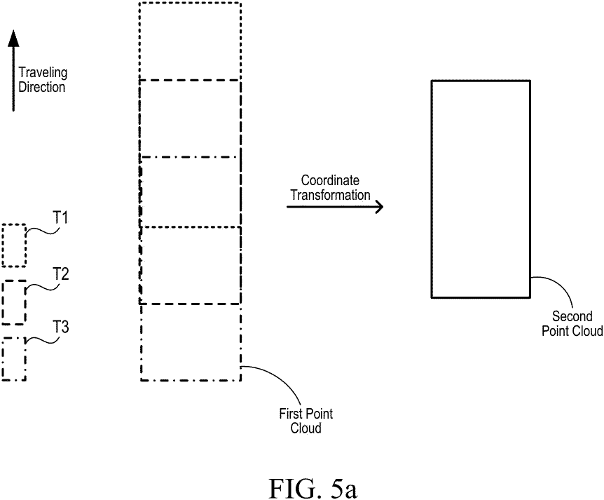

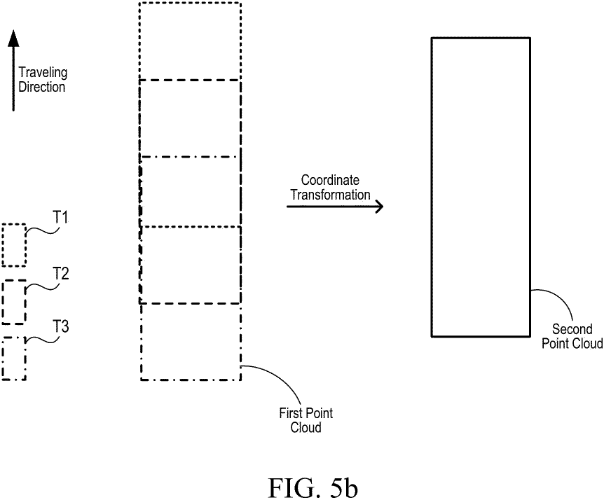

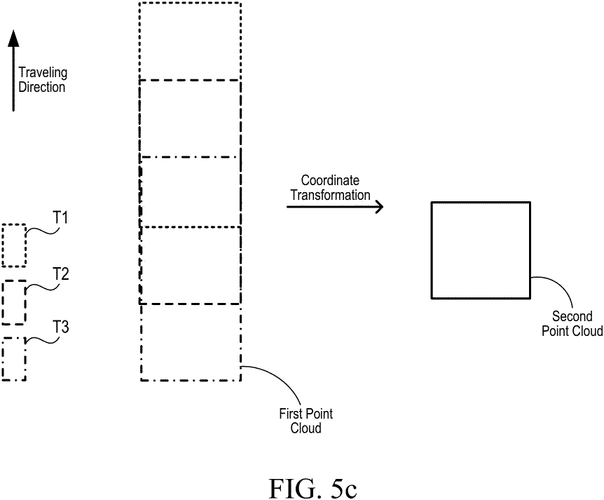

The three-dimensional point cloud, when displayed, can be displayed according to a specified display direction. The specified display direction may be a preset display direction or a display direction input by an annotator. For example, in some embodiments, a frame of three-dimensional point cloud can be displayed according to a preset display direction after it is read by the data processing device. For another example, in some embodiments, when an annotator needs to carefully observe the scene or object represented by the three-dimensional point cloud, a desired display direction can be selected and input, and the data processing device displays the three-dimensional point cloud according to the received display direction for easy observation and identification by the annotator. The point cloud frame can be construed as three-dimensional point cloud displayed in a specific direction. For example, for the convenience of understanding the scheme, a top view is adopted in FIGS. 5-7.

The data processing device 1 executing at least one machine-executable instruction to implement the data processing method is described below.

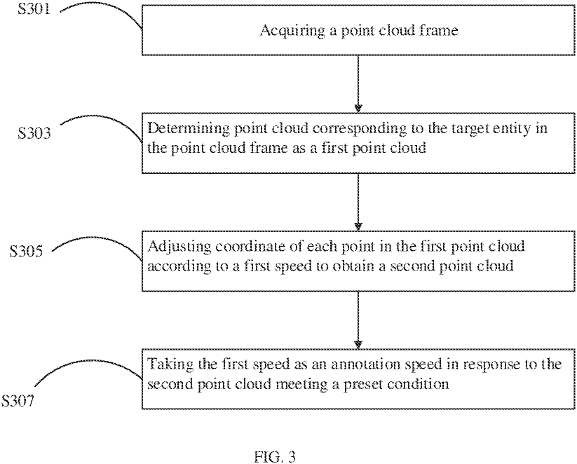

FIG. 3 shows a data processing method provided in an embodiment of the present application, that is, procedures of data processing by a data processing device, comprising operations as discussed below:

S301, obtaining a point cloud frame, wherein the point cloud frame comprises point cloud from at least two acquisition periods.

For example, the point cloud frame can be displayed through the data processing device; the point cloud frame comprises point cloud from at least two acquisition periods. The point cloud can be acquired through a LIDAR; in this case, the acquisition period is the amount of time the LIDAR spends scanning around once. A target entity (e.g. a vehicle) is locating in a field of view of the LIDAR during at least two acquisition periods, so the LIDAR can obtain point cloud corresponding to the target entity from at least two acquisition periods.

Besides, in order to achieve this scheme, point cloud from at least two acquisition periods are generally selected. In specific implementation, the point cloud from at least two acquisition periods can be displayed in the same point cloud frame, or separately in different point cloud frames.

S303, determining point cloud corresponding to the target entity in the point cloud frame as a first point cloud.

For example, annotation data can be input by an annotator through a human-computer interaction interface provided by the data processing device to determine the first point cloud. For example, specific parameter values are directly input into a data input box in the human-computer interaction interface, and a button or a key in the human-computer interaction interface is clicked on, wherein the button or the key represents a corresponding preset instruction or data; alternatively, a corresponding option is selected in a drop-down menu provided in the human-computer interaction interface, wherein the drop-down menu may comprise first-level menus or multi-level submenus, and each submenu may comprise one or a plurality of options; the data processing device receives annotation data input by the annotator through the human-computer interaction interface, so as to determine point cloud corresponding to the target entity in the point cloud frame, that is, the first point cloud.

Alternatively, the coordinate of each point in the point cloud corresponding to the target entity in an image can be calculated using an object detection algorithm; in some application scenarios, manual verification and calibration can be performed by the annotator on the results identified by the object detection algorithm, and the verified and calibrated results are used as the first point cloud.

Alternatively, the point cloud frame can be processed through an algorithm model obtained from pre-training to obtain a three-dimensional annotation box of the target entity, and then the point cloud with coordinates in the three-dimensional annotation box can be determined as the point cloud corresponding to the target entity. Besides, manual verification and calibration can still be performed by the annotator on the results identified by the algorithm model, and the verified and calibrated results are used as the first point cloud.

S305, adjusting coordinate of each point in the first point cloud according to a first speed to obtain a second point cloud, wherein the first speed represents the moving speed of the target entity.

For example, the first speed can be input by an annotator through the human-computer interaction interface provided by the data processing device, for example, specific parameters are directly input into a data input box in the human-computer interaction interface, and a button or a key in the human-computer interaction interface is clicked on, wherein the button or the key represents a corresponding preset instruction or data; alternatively, a corresponding option is selected in a drop-down menu provided in the human-computer interaction interface, wherein the drop-down menu may comprise first-level menus or multi-level submenus, and each submenu may comprise one or a plurality of options; the data processing device receives the first speed input by the annotator through the human-computer interaction interface. Alternatively, a preset parameter value can be used as the first speed.

Besides, as the timestamps corresponding to each point cloud are different, and even the timestamps corresponding to each point in the point clouds are different, by giving a assumed speed value, such as the first speed, the coordinates of the points in the first point cloud corresponding to the target entity are adjusted to positions at a specified moment according to the first speed.

S307, taking the first speed as an annotation speed in response to the second point cloud meeting a preset condition.

For example, the preset condition may be set in advance; when the second point cloud obtained after the coordinate adjustment meets the preset condition, the first speed is used as the annotation speed representing the moving speed of the target object. The preset condition may be set according to actual demands or past experience, which is not limited herein.

According to the method shown in FIG. 3, the data processing device adjusts the coordinate of each point in the first point cloud corresponding to the target entity in different acquisition periods to obtain the second point cloud, and the annotation speed of the target entity is further determined by deciding whether the second point cloud meets the preset condition. By the above scheme, richer annotation data comprising speed information of the target entity can be obtained for the point cloud set for algorithm training or other purposes.

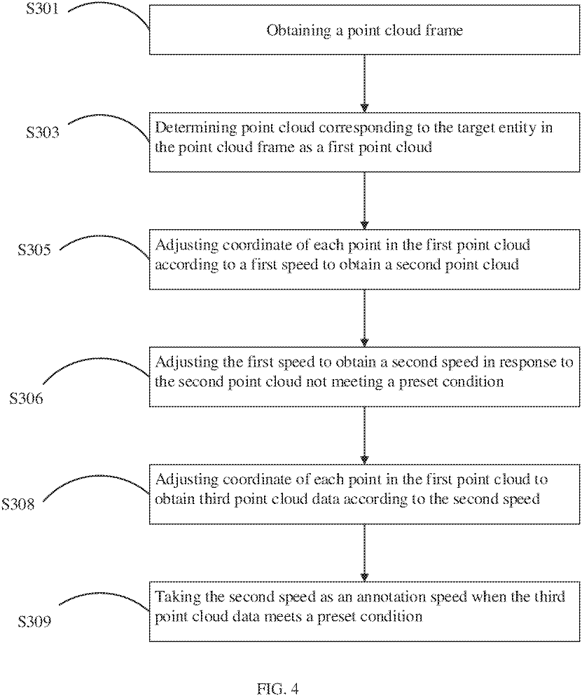

Further, as shown in FIG. 4, in some embodiments, if the second point cloud does not meet the preset condition, the scheme further includes:

S306, adjusting the first speed to obtain a second speed in response to the second point cloud not meeting the preset condition;

S308, adjusting each point in the first point cloud to obtain third point cloud according to the second speed; and

S309, taking the second speed as an annotation speed when the third point cloud meets the preset condition.

This is because the second point cloud obtained after the first point cloud is adjusted according to the first speed in S305 may not meet the preset condition. In this case, the first speed needs to be adjusted, such that the point cloud adjusted according to the second speed meet the preset condition.

For example, when the first speed is adjusted in S306, the first speed can be sequentially adjusted according to a preset adjustment step size as the second speed; alternatively, the speed value input by an annotator through the human-computer interaction interface is received as the second speed. However, in practice, it is often difficult to obtain the annotation speed by one adjustment. In this case, multiple adjustments need to be performed on the speed so as to obtain an annotation speed that enables the adjusted point cloud to meet the preset condition.

In some embodiments, the adjustment of the coordinate of each point in the first point cloud according to a first speed to obtain a second point cloud in S305 comprises: adjusting the coordinate of each point in the first point cloud according to an adjustment function, wherein the adjustment function is a relation function between coordinate transformation and the first speed, the target moment and the point cloud acquisition moment.

For example, as the first speed represents the assumed speed of the target entity, and the first point cloud is a point cloud corresponding to the target entity, when the speed of the target entity is set to be the first speed, the first point cloud corresponding to the target entity can be considered to have the first speed as well. According to the traveling state of the target entity, the adjustment manners can be divided into the following categories:

a1, if the target entity is traveling at a constant speed in a linear manner, when the first point cloud is adjusted, as all point clouds in the first point cloud have their acquisition moments, and the point cloud corresponding to the target entity traveling at the given first speed will have different positions at different acquisition moments, the adjustment function is a relation function between coordinate transformation and the first speed, the target moment and the point cloud acquisition moment; in this case, coordinate transformation can be performed on the point cloud corresponding to the target entity according to the determined traveling direction of the target entity, the first speed and the specified target moment to obtain the second point cloud.

a2, if the target entity is traveling at a non-constant speed in a linear manner, the target entity will further has a certain acceleration in addition to the first speed; therefore, when the coordinates of the first point cloud is adjusted, the adjustment function is a relation function between coordinate transformation and the first speed, the acceleration, the target moment and the point cloud acquisition moment, and the traveling direction, the first speed, the acceleration and the specified target moment need to be considered at the same time, such that each point of the point cloud are adjusted from the coordinate at the acquisition moment to the corresponding coordinate at the target moment, thereby obtaining the second point cloud.

a3, if the target entity is traveling at a constant speed in a non-linear manner, the target entity will further has an initial angle and an angular velocity in addition to the first speed; therefore, the adjustment function is a relation function between coordinate transformation and the first speed, the angular velocity, the initial angle, the target moment and the point cloud acquisition moment; in this case, coordinate transformation can be performed on the point cloud corresponding to the target entity according to the determined traveling direction of the target entity, the first speed, the initial angle, the angular velocity and the specified target moment to obtain the second point cloud.

a4, if the target entity is traveling at a non-constant speed in a non-linear manner, the target entity will further has an acceleration, an initial angle and an angular velocity in addition to the first speed; therefore, the adjustment function is a relation function between coordinate transformation and the first speed, the acceleration, the angular velocity, the initial angle, the target moment and the point cloud acquisition moment; in this case, coordinate transformation can be performed on the point cloud corresponding to the target entity according to the determined traveling direction of the target entity, the first speed, the acceleration, the initial angle, the angular velocity and the specified target moment to obtain the second point cloud.

The acceleration, the initial angle, and the angular velocity can be input by an annotator through the human-computer interaction interface of the data processing device, or can be set in other manners, and the traveling direction of the target entity can be determined using an image corresponding to the point cloud frame displayed by the front-end processing 13, which is not limited herein. It should be noted that the values of the acceleration, the initial angle and the angular velocity should also be adjustable according to actual demands.

Similarly, when the coordinate of each point in the first point cloud are adjusted according to the second speed to obtain a third point cloud, reference can be made to the above four manners a1-a4, which are not described herein again.

In some embodiments, the manners of deciding whether the second point cloud meets the preset condition includes:

b1, receiving a confirmation instruction input by an annotator, wherein the confirmation instruction represents that the second point cloud meets the preset condition.

Specifically, an annotator can decide whether the second point cloud meets the requirement from experience; if it does, the annotator inputs a confirmation instruction through the human-computer interaction interface.

b2, generating a three-dimensional annotation box of the second point cloud; the three-dimensional annotation box meets the preset size requirement.

For example, an annotator can input annotation data of the second point cloud through the human-computer interaction interface, and the data processing device generates a three-dimensional annotation box of the second point cloud according to the input annotation data; whether the second point cloud meets the preset condition is determined by deciding whether the size of the three-dimensional annotation box meets the preset size requirement; alternatively, a minimum three-dimensional annotation box surrounding the second point cloud can be automatically generated by an algorithm, and whether the second point cloud meets the preset condition is further determined by deciding whether the size of the three-dimensional annotation box meets the preset size requirement.

The specific size requirement may be length, width and height ranges, or maximum values of length, width and height set for the three-dimensional annotation box. The size requirement is set up according to actual demands, which is not limited herein.

Similarly, when deciding whether the third point cloud meets the preset condition, the above two manners b1 and b2 can also be adopted, which are not described herein again.

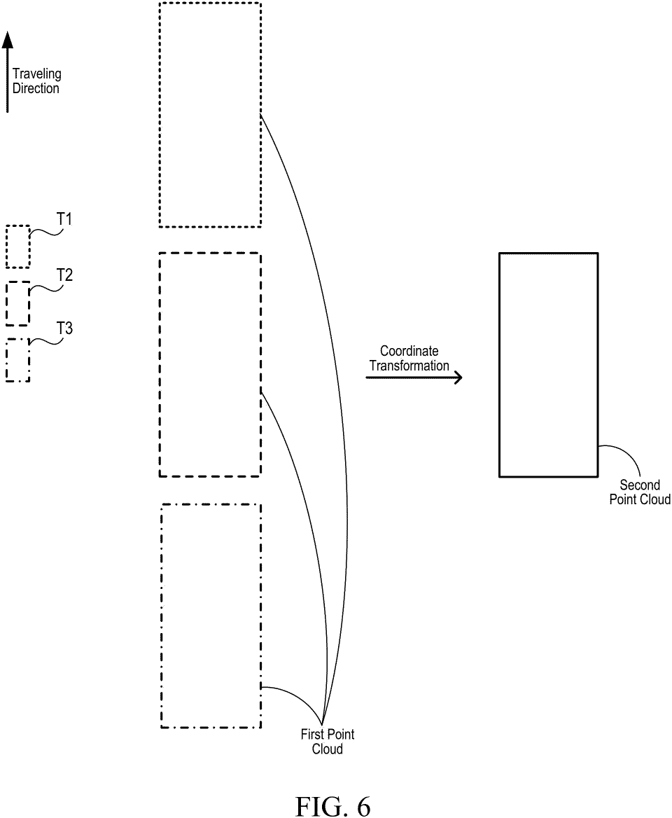

FIGS. 5a-5c and FIG. 6 show examples of the application of the scheme in specific scenarios, wherein FIG. 5 shows diagrams before and after coordinate transformation in three adjacent acquisition periods selected, and FIG. 6 show a diagram before and after coordinate transformation in three far-apart acquisition periods selected. For the convenience of understanding, a top view is adopted in the diagrams. It should be understood, however, that the choice of views does not limit the present application.

As shown in FIGS. 5a-5c, the target entity travels along the road at a constant speed, and the point clouds of the target entity corresponding to three acquisition periods (T1, T2 and T3) are displayed in the same point cloud frame. For the convenience of understanding the scheme, three boxes are used to identify the point cloud from the acquisition periods. It can be seen that the point clouds of the target entity corresponding to different acquisition periods overlap, leading to the fact that the presented point clouds spread to a longer range along the traveling direction. In specific operation, an annotator can input the first speed through the human-computer interaction interface, and coordinate transformation is performed on the point clouds from the three acquisition periods along the traveling direction according to the first speed and the specified target moment to obtain the second point cloud. Assuming that other conditions remain unchanged, for the target entity, when the target entity is in a static state, the acquired three-dimensional point cloud corresponding to the target entity should have a certain size: L, W and H. As shown in FIG. 5a, if the given first speed is close to the actual speed of the target entity, the length of the second point cloud formed after coordinate transformation along the traveling direction will be close to the length L of the corresponding point cloud when the target entity is in a static state; as shown in FIG. 5b, if the given first speed is too low and differs greatly from the actual speed of the target entity, the length of the second point cloud formed after coordinate transformation along the traveling direction will be far greater than the length L of the corresponding point cloud when the target entity is in a static state; as shown in FIG. 5c, if the given first speed is too high, the length of the second point cloud formed after the coordinate transformation along the traveling direction will be far smaller than the length L of the corresponding point cloud when the target entity is in a static state.

After coordinate transformation is performed, an annotator can check result of the coordinate transformation through the human-computer interaction interface and input a corresponding confirmation instruction or an adjustment instruction; alternatively, a minimum three-dimensional annotation box surrounding the second point cloud can be generated by the data processing device, and then the size of the minimum three-dimensional annotation box is compared with a preset three-dimensional annotation box size, wherein the preset three-dimensional annotation box size can be set with reference to the size (L, W, H) of the corresponding point cloud when the target entity is in a static state. If the given first speed is close to the actual speed of the target entity, the size of the minimum three-dimensional annotation box should be close to the size of the corresponding point cloud when the target entity is in a static state, and thus whether the first speed could be used as the annotation speed or needs to be further adjusted can be determined.

As shown in FIG. 6, the target entity travels along the road at a constant speed, and the point clouds of the target entity corresponding to three acquisition periods (T1, T2 and T3) are displayed in the same point cloud frame or separately in different point cloud frames, and are identified by three boxes for easy viewing. It can be seen that, as the selected periods are far apart from each other, the point clouds of the target entity corresponding to different acquisition periods do not overlap. In specific operation, an annotator can still input the first speed through the human-computer interaction interface, and coordinate transformation is performed on the point clouds from the three acquisition periods along the traveling direction according to the first speed and the specified target moment to obtain the second point cloud. If the given first speed is close to the actual speed of the target entity, the length of the second point cloud formed after coordinate transformation along the traveling direction will be close to the length L of the corresponding point cloud when the target entity is in a static state; in this case, an annotator can check result of the coordinate transformation through the human-computer interaction interface and input a corresponding confirmation instruction or an adjustment instruction; alternatively, a minimum three-dimensional annotation box surrounding the second point cloud can be generated by the data processing device, and then the size of the minimum three-dimensional annotation box is compared with a preset three-dimensional annotation box size; if the given first speed is close to the actual speed of the target entity, the size of the minimum three-dimensional annotation box should be close to the size of the corresponding point cloud when the target entity is in a static state, and thus whether the first speed could be used as the annotation speed or needs to be further adjusted can be determined.

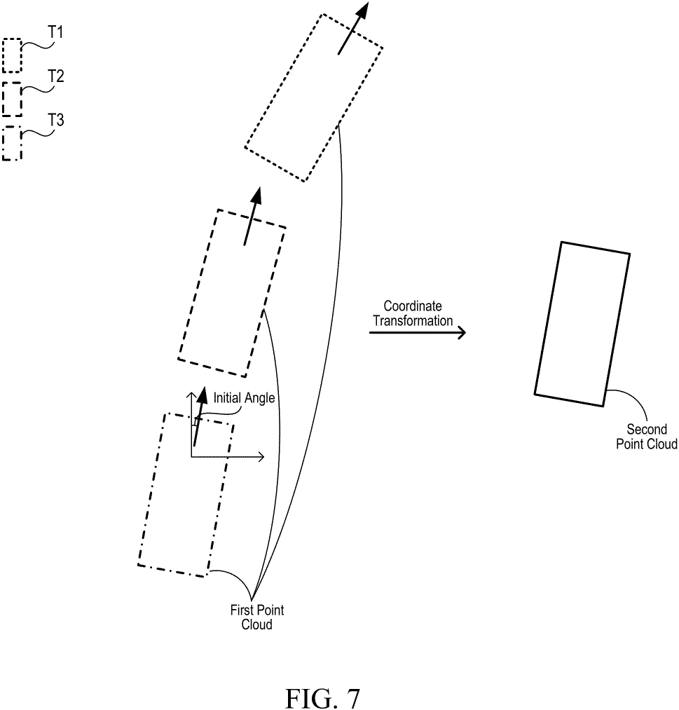

Further, as shown in FIG. 7, the target entity makes a turn at a certain initial angle and a constant speed, and the point clouds of the target entity corresponding to three acquisition periods (T1, T2 and T3) are displayed in the same point cloud frame or in different point cloud frames, and are identified by three boxes in the drawing for easy viewing. In this case, the target entity moves at a certain angular velocity in addition to a first speed forward. In specific operation, an annotator can input the first speed, the initial angle and the angular velocity through the human-computer interaction interface, and coordinate transformation is performed on the first point cloud corresponding to the target entity in the three periods through a relation function between the coordinate transformation and the first speed, the angular velocity, the initial angle, the target moment and the point cloud acquisition moment to obtain a second point cloud. If the given first speed, the initial speed and the angular velocity are close to the actual speed of the target entity, the size of the second point cloud formed after coordinate transformation will be close to the size of the corresponding point cloud when the target entity is in a static state; in this case, an annotator can check result of the coordinate transformation through the human-computer interaction interface and input a corresponding confirmation instruction or an adjustment instruction; alternatively, a minimum three-dimensional annotation box of the second point cloud can be generated by the data processing device, and then the size of the minimum three-dimensional annotation box is compared with a preset three-dimensional annotation box size; if the given first speed is close to the actual speed of the target entity, the three-dimensional annotation box of the second point cloud formed after coordinate transformation should be close to the size of the corresponding point cloud when the target entity is in a static state, and thus whether the first speed could be used as the annotation speed or needs to be further adjusted, and whether the initial angle and the angular velocity need to be adjusted can be determined.

It should be noted that if there is a change in the angular velocity, an angular acceleration parameter can be further created for adjustment, so as to achieve the coordinate transformation of the first point cloud, which is not described herein again.

By the above scheme, the characteristics of the point cloud, as well as the associative relationship between the target entity and its corresponding point cloud, can be effectively utilized. By performing coordinate transformation on the point cloud of the same target entity acquired at different moments according to parameters such as a certain speed and traveling direction, a point cloud data set comprising parameters such as speed can be simply and quickly generated for use in subsequent algorithm training, thereby improving the performance of the autonomous driving system.

Features and embodiments of the above-described methods/techniques are described below.

1. A data processing method, comprising: obtaining a point cloud frame, wherein the point cloud frame comprises point cloud from at least two acquisition periods; determining point cloud corresponding to the target entity in the point cloud frame as a first point cloud; adjusting coordinate of each point in the first point cloud according to a first speed to obtain a second point cloud; and taking the first speed as an annotation speed in response to the second point cloud meeting a preset condition, wherein the annotation speed represents a moving speed of the target entity.

2. The data processing method of clause 1, wherein the determining point cloud corresponding to the target entity in the point cloud frame as the first point cloud comprises: processing the point cloud frame through a preset algorithm model to obtain a three-dimensional annotation box of the target entity; and determining point cloud in the three-dimensional annotation box as the first point cloud.

3. The data processing method of clause 1, wherein the determining point cloud corresponding to the target entity in the point cloud frame as the first point cloud comprises: receiving annotation data of the target entity; generating a three-dimensional annotation box of the target entity based on the annotation data; and determining point cloud in the three-dimensional annotation box as the first point cloud.

4. The data processing method of clause 1, wherein the adjusting the coordinate of each point in the first point cloud according to the first speed to obtain the second point cloud comprises: adjusting the coordinate of each point in the first point cloud according to an adjustment function, wherein the adjustment function is a relation function between coordinate transformation and the first speed, a target moment and a point cloud acquisition moment.

5. The data processing method of clause 1, further comprising: adjusting the first speed to obtain a second speed in response to the second point cloud not meeting the preset condition; adjusting coordinate of each point in the first point cloud to obtain third point cloud according to the second speed; and taking the second speed as the annotation speed in response to the third point cloud meeting a preset condition.

6. The data processing method of clause 5, wherein the adjusting the first speed to obtain the second speed comprises: adjusting the first speed according to a preset adjustment step size; or receiving a speed value input by a user as the second speed.

7. The data processing method of clause 1, wherein the second point cloud meeting the preset condition comprises: receiving a confirmation instruction input by a user, wherein the confirmation instruction represents that the second point cloud meets the preset condition.

8. The data processing method of clause 1, wherein the second point cloud meeting the preset condition comprises: generating a three-dimensional annotation box of the second point cloud, wherein the three-dimensional annotation box meets a preset size requirement.

9. A data processing device, comprising a processor and a memory, wherein the memory stores at least one machine-executable instruction, and the processor executes the at least one machine-executable instruction to implement the method comprising: obtaining a point cloud frame, wherein the point cloud frame comprises point cloud from at least two acquisition periods; determining point cloud corresponding to the target entity in the point cloud frame as a first point cloud; adjusting coordinate of each point in the first point cloud according to a first speed to obtain a second point cloud; and taking the first speed as an annotation speed in response to the second point cloud meeting a preset condition, wherein the annotation speed represents a moving speed of the target entity.

10. The data processing device of clause 9, wherein the determining point cloud corresponding to the target entity in the point cloud frame as the first point cloud comprises: processing the point cloud frame through a preset algorithm model to obtain a three-dimensional annotation box of the target entity; and determining point cloud in the three-dimensional annotation box as the first point cloud.

11. The device of clause 9, wherein the determining point cloud corresponding to the target entity in the point cloud frame as the first point cloud comprises: receiving annotation data of the target entity; generating a three-dimensional annotation box of the target entity based on the annotation data; and determining point cloud in the three-dimensional annotation box as the first point cloud.

12. The device of clause 9, wherein the adjusting the coordinate of each point in the first point cloud according to the first speed to obtain the second point cloud comprises: adjusting the coordinate of each point in the first point cloud according to an adjustment function, wherein the adjustment function is a relation function between coordinate transformation and the first speed, a target moment and a point cloud acquisition moment.

13. The device of clause 9, wherein the second point cloud meeting a preset condition comprises: receiving a confirmation instruction input by a user, wherein the confirmation instruction represents that the second point cloud meets the preset condition.

14. The device of clause 9, wherein the second point cloud meeting the preset condition comprises: generating a three-dimensional annotation box of the second point cloud, wherein the three-dimensional annotation box meets a preset size requirement.

15. A computer-readable storage medium, having a computer program stored thereon, wherein the program is executed by a processor to implement the method comprising: obtaining a point cloud frame, wherein the point cloud frame comprises point cloud from at least two acquisition periods; determining point cloud corresponding to the target entity in the point cloud frame as a first point cloud; adjusting coordinate of each point in the first point cloud according to a first speed to obtain a second point cloud; and taking the first speed as an annotation speed in response to the second point cloud meeting a preset condition, wherein the annotation speed represents a moving speed of the target entity.

16. The computer-readable storage medium of clause 15, wherein the determining point cloud corresponding to the target entity in the point cloud frame as the first point cloud specifically comprises: processing the point cloud frame through a preset algorithm model to obtain a three-dimensional annotation box of the target entity; and determining point cloud in the three-dimensional annotation box as the first point cloud.

17. The computer-readable storage medium of clause 15, wherein the determining point cloud corresponding to the target entity in the point cloud frame as the first point cloud comprises: receiving annotation data of the target entity; generating a three-dimensional annotation box of the target entity based on the annotation data; and determining point cloud in the three-dimensional annotation box as the first point cloud.

18. The computer-readable storage medium of clause 15, wherein the adjusting the coordinate of each point in the first point cloud according to the first speed to obtain the second point cloud comprises: adjusting the coordinate of each point in the first point cloud according to an adjustment function, wherein the adjustment function is a relation function between coordinate transformation and the first speed, a target moment and a point cloud acquisition moment.

19. The computer-readable storage medium of clause 15, wherein the second point cloud meeting a preset condition comprises: receiving a confirmation instruction input by a user, wherein the confirmation instruction represents that the second point cloud meets the preset condition.

20. The computer-readable storage medium of clause 15, wherein the second point cloud meeting the preset condition comprises: generating a three-dimensional annotation box of the second point cloud, wherein the three-dimensional annotation box meets a preset size requirement.

It should be understood by those skilled in the art that embodiments of the present application may be provided as a method, a system, or a computer program product. Accordingly, the present application may take the forms of a hardware-only embodiment, a software-only embodiment or an embodiment combining software and hardware. Furthermore, the present application may take the form of a computer program product implemented on one or more computer-usable storage media (including, but not limited to, disk memory, CD-ROM, optical memory, and the like) containing computer-usable program codes.

The present application is described with reference to flowcharts and/or block diagrams of a method, a device (system), and a computer program product according to the embodiments of the present application. It should be understood that each procedure and/or block of the flowcharts and/or block diagrams, and a combination of procedures and/or blocks in the flowcharts and/or block diagrams, can be implemented by computer program instructions. These computer program instructions may be provided to a processor of a general purpose computer, a dedicated computer, an embedded processor or other programmable data processing device to produce a machine, such that the instructions executed by the processor of the computer or other programmable data processing devices produce a means for implementing the functions specified in one or more procedures in the flowcharts and/or one or more blocks of block diagrams.

These computer program instructions may also be stored in a computer-readable memory that can direct a computer or other programmable data processing devices to operate in a particular manner, such that the instructions stored in the computer-readable memory produce a product comprising an instruction means which implements the functions specified in one or more procedures in the flowcharts and/or one or more blocks of block diagrams.

These computer program instructions may also be loaded onto a computer or other programmable data processing devices to allow a series of operation steps to be performed on the computer or other programmable apparatus to produce a computer implemented process, such that the instructions executed on the computer or other programmable devices provide steps for implementing the functions specified in one or more procedures in the flowcharts and/or one or more blocks of block diagrams.

The principle and the implementation of the present application are explained by applying specific embodiments in the present application, and the description of the above embodiments is only used for facilitating the understanding of the method and the core idea of the present application. Besides, for one of ordinary skilled in the art, according to the idea of the present application, there will be changes in the specific embodiments and the application range. In summary, the content of the specification should not be construed as a limitation to the present application.

What is claimed is:

1. A data processing method, comprising:
obtaining a point cloud frame comprising point cloud from at least two acquisition periods;
determining point cloud corresponding to the target entity in the point cloud frame as a first point cloud;
adjusting coordinate of each point in the first point cloud according to a first speed to obtain a second point cloud; and
taking the first speed as an annotation speed in response to the second point cloud meeting a preset condition, wherein the annotation speed represents a moving speed of the target entity.

2. The data processing method of claim 1, wherein the determining point cloud corresponding to the target entity in the point cloud frame as the first point cloud comprises:
processing the point cloud frame through a preset algorithm model to obtain a three-dimensional annotation box of the target entity; and
determining point cloud in the three-dimensional annotation box as the first point cloud.

3. The data processing method of claim 1, wherein the determining point cloud corresponding to the target entity in the point cloud frame as the first point cloud comprises:
receiving annotation data of the target entity;
generating a three-dimensional annotation box of the target entity based on the annotation data; and
determining point cloud in the three-dimensional annotation box as the first point cloud.

4. The data processing method of claim 1, wherein the adjusting the coordinate of each point in the first point cloud according to the first speed to obtain the second point cloud comprises:
adjusting the coordinate of each point in the first point cloud according to an adjustment function, wherein
the adjustment function is a relation function between coordinate transformation and the first speed, a target moment and a point cloud acquisition moment.

5. The data processing method of claim 1, further comprising:
adjusting the first speed to obtain a second speed in response to the second point cloud not meeting the preset condition;
adjusting coordinate of each point in the first point cloud to obtain third point cloud according to the second speed; and
taking the second speed as the annotation speed in response to the third point cloud meeting a preset condition.

6. The data processing method of claim 5, wherein the adjusting the first speed to obtain the second speed comprises:
adjusting the first speed according to a preset adjustment step size; or
receiving a speed value input by a user as the second speed.

7. The data processing method of claim 1, wherein the second point cloud meeting the preset condition comprises:
receiving a confirmation instruction input by a user, wherein the confirmation instruction represents that the second point cloud meets the preset condition.

8. The data processing method of claim 1, wherein the second point cloud meeting the preset condition comprises:
generating a three-dimensional annotation box of the second point cloud, wherein
the three-dimensional annotation box meets a preset size requirement.

9. A data processing device, comprising a processor and a memory, wherein the memory stores at least one machine-executable instruction, and the processor executes the at least one machine-executable instruction to implement a method comprising:
obtaining a point cloud frame, wherein the point cloud frame comprises point cloud from at least two acquisition periods;
determining point cloud corresponding to a target entity in the point cloud frame as a first point cloud;
adjusting coordinate of each point in the first point cloud according to a first speed to obtain a second point cloud; and
taking the first speed as an annotation speed in response to the second point cloud meeting a preset condition, wherein the annotation speed represents a moving speed of the target entity.

10. The data processing device of claim 9, wherein the determining point cloud corresponding to the target entity in the point cloud frame as the first point cloud comprises:
processing the point cloud frame through a preset algorithm model to obtain a three-dimensional annotation box of the target entity; and
determining point cloud in the three-dimensional annotation box as the first point cloud.

11. The device of claim 9, wherein the determining point cloud corresponding to the target entity in the point cloud frame as the first point cloud comprises:
receiving annotation data of the target entity;
generating a three-dimensional annotation box of the target entity based on the annotation data; and
determining point cloud in the three-dimensional annotation box as the first point cloud.

12. The device of claim 9, wherein the adjusting the coordinate of each point in the first point cloud according to the first speed to obtain the second point cloud comprises:
adjusting the coordinate of each point in the first point cloud according to an adjustment function, wherein
the adjustment function is a relation function between coordinate transformation and the first speed, a target moment and a point cloud acquisition moment.

13. The device of claim 9, wherein the second point cloud meeting a preset condition comprises:
receiving a confirmation instruction input by a user, wherein the confirmation instruction represents that the second point cloud meets the preset condition.

14. The device of claim 9, wherein the second point cloud meeting the preset condition comprises:
generating a three-dimensional annotation box of the second point cloud, wherein
the three-dimensional annotation box meets a preset size requirement.

15. A computer-readable storage medium, having a computer program stored thereon, wherein the program is executed by a processor to implement a method comprising:
obtaining a point cloud frame, wherein the point cloud frame comprises point cloud from at least two acquisition periods;
determining point cloud corresponding to a target entity in the point cloud frame as a first point cloud;
adjusting coordinate of each point in the first point cloud according to a first speed to obtain a second point cloud; and
taking the first speed as an annotation speed in response to the second point cloud meeting a preset condition, wherein the annotation speed represents a moving speed of the target entity.

16. The computer-readable storage medium of claim 15, wherein the determining point cloud corresponding to the target entity in the point cloud frame as the first point cloud specifically comprises:
processing the point cloud frame through a preset algorithm model to obtain a three-dimensional annotation box of the target entity; and
determining point cloud in the three-dimensional annotation box as the first point cloud.

17. The computer-readable storage medium of claim 15, wherein the determining point cloud corresponding to the target entity in the point cloud frame as the first point cloud comprises:
receiving annotation data of the target entity;
generating a three-dimensional annotation box of the target entity based on the annotation data; and
determining point cloud in the three-dimensional annotation box as the first point cloud.

18. The computer-readable storage medium of claim 15, wherein the adjusting the coordinate of each point in the first point cloud according to the first speed to obtain the second point cloud comprises:
adjusting the coordinate of each point in the first point cloud according to an adjustment function, wherein
the adjustment function is a relation function between coordinate transformation and the first speed, a target moment and a point cloud acquisition moment.

19. The computer-readable storage medium of claim 15, wherein the second point cloud meeting a preset condition comprises:
receiving a confirmation instruction input by a user, wherein the confirmation instruction represents that the second point cloud meets the preset condition.

20. The computer-readable storage medium of claim 15, wherein the second point cloud meeting the preset condition comprises:
generating a three-dimensional annotation box of the second point cloud, wherein
the three-dimensional annotation box meets a preset size requirement.
